(19) United States
(12) Patent Application Publication
(10) Pub. No.: US 2021/0351933 A1
(43) Pub. Date: Nov. 11, 2021

(54) SECURE TIME SYNCHRONIZATION

(71) Applicants: SCPTIME, La Mure (FR); INSTITUT POLYTECHNIQUE DE GRENOBLE, GRENOBLE (FR); UNIVERSITE GRENOBLE ALPES, SAINT MARTIN D'HERES (FR); CENTRE NATIONAL DE LA RECHERCHE SCIENTIFIQUE, PARIS CEDEX 16 (FR)

(72) Inventors: Andrzej DUDA, Saint Ismier (FR); Faten MKACHER, Grenoble (FR)

(21) Appl. No.: 17/277,559

(22) PCT Filed: Sep. 26, 2019
(86) PCT No.: PCT/EP2019/076013

§ 371 Date: Mar. 18, 2021

(30) Foreign Application Priority Data
Sep. 27, 2018 (FR) 1858873

(51) Int. Cl. H04L 9/32

(52) U.S. Cl. CPC H04L 9/3242; H04L 9/3263; H04L 9/3297

(57) ABSTRACT

The present disclosure relates to a time client device comprising a network interface for communicating over a communication network, the time client device being configured to: receive, over the communication network from an authentication server (AS), a first key, and a first value containing the first key in encrypted form; generate a second value using the first key; and during a time synchronization phase, transmit to a time server (TS) the first and second values.

The present patent application claims priority from the French patent application filed on Sep. 27, 2018 and assigned application no. FR 18/58873, the contents of which is hereby incorporated by reference.

### TECHNICAL FIELD

The present disclosure relates generally to electronic devices capable of communication over communication networks, to a secure time synchronization protocol, and to a device and method for securely obtaining a time estimation.

### BACKGROUND ART

FIG. 1 schematically illustrates a system 100 for providing time synchronization. The system comprises a time server (TS) and a time client device (TC) that communicate over a communication network. The time client device TC is a network entity that wishes to obtain secure time synchronization, for example in order to synchronize its local clock 102 with a precise reference. For this, it contacts the time server TS via the communication network using a time synchronization protocol (TIME SYNC), such as the network time protocol (NTP).

The time server TS for example comprises a precise time source 104, such as a micro atomic oscillator or other means for maintaining a precise time reference.

The time client device TC may request time synchronization from the time server TS during an initialization phase following a first activation of the time client TC, and this operation may be repeated at regular intervals in order to ensure time synchronization between the local clock 102 of the time client device TC and the precise time source 104 of the time server TS.

FIG. 1 illustrates the case of a single time client device TC. However, the time client device TC and time server TS may form part of a relatively large network in which there are many time client devices TC served by the time server TS. For example, for applications such as the dissemination of certified legal time for commercial transactions, there may be many points of sale requiring time synchronization. However, it has been found that when a time server TS is required to provide services to many time client devices, the capabilities of the time server TS may become overloaded and lead to synchronization delays, or even synchronization failure. There is a technical problem in providing a system capable of handling requests from many time client devices in a network.

A further technical problem in the system of FIG. 1 is that in order to authenticate the time server, the server certificate should generally be verified, including its period of validity. However, upon initial activation of the time client device TC, this device may have no notion of time. This leads to a Catch-22 situation in which the time client device TC should have a prior knowledge of time in order to validate the time server certificate, but obtaining time information from the time server TS requires prior certificate validation.

### SUMMARY OF INVENTION

It is an aim of embodiments of the present disclosure to at least partially address one or more problems in the prior art.

According to one aspect, there is provided a time client device comprising a network interface for communicating over a communication network, the time client device being configured to: receive, over the communication network from an authentication server, a first key, and a first value containing the first key in encrypted form; generate a second value using the first key; and during a time synchronization phase, transmit to a time server the first and second values.

According to one embodiment, the time client device is configured, during the time synchronization phase, to: transmit the first value to the time server in a first message comprising a first timestamp; and transmit the second value to the time server in a second message.

According to one embodiment, the second value is a message authentication code of the first message generated using the first key.

According to one embodiment, the first value further contains an indication of the encryption algorithm to be used to generate the second value.

According to one embodiment, the time client device is further configured to transmit over the communication network a request to the authentication server for the first key and the first value, the request containing an identifier of the time client device, the identifier for example being an IP (Internet Protocol) address.

According to one embodiment, the time client device is configured to further include in the request an identifier of the time server, the identifier of the time server for example being an IP address.

According to one embodiment, the first value is encrypted using a second key not known by the time client device.

According to one embodiment, the time client device is further configured to: receive from the time server a third message containing one or more further timestamps; receive from the time server a third value corresponding to: a message authentication code of at least part of the first message and/or at least part of the third message generated using the first key; or a digital signature of at least part of the first message and/or at least part of the third message generated based on a private key; and authenticate the third message by verifying the third value based on the first key or on a public key.

According to one embodiment, the time client device is further configured to: generate a time estimation by requesting from a node in a blockchain network headers of a series of blocks of a blockchain, extracting a timestamp from the header of a most recent block of the series; and generating the time estimation based on the extracted timestamp; and validate an authentication certificate of the authentication server based on the time estimation.

According to a further aspect, there is provided a time synchronization system comprising: an authentication server comprising a network interface for communicating over a communication network, the authentication server being configured to transmit, over the communication network to a first time client device, a first key, and a first value containing the first key in encrypted form; and a time server configured to receive from the first time client device, during a time synchronization phase, the first value and a second value generated using the first key, the time server being configured to authenticate the first time client device based on the second value.

According to one embodiment: the authentication server is further configured to transmit, over the communication network to a second time client device, a third key, and a third value containing the third key in encrypted form; and the time server is further configured to receive from the second time client device, during a time synchronization phase, the third value and a fourth value generated using the third key, the time server being configured to authenticate the second time client device based on the fourth value.

According to a further aspect, there is provided a method of obtaining time synchronization by a time client device comprising a network interface for communicating over a communication network, the method comprising: receiving, over the communication network from an authentication server, a first key, and a first value containing the first key in encrypted form; generating, by the time client device, a second value using the first key; and during a time synchronization phase, transmitting by the time client device the first and second values to a time server.

According to yet a further aspect, there is provided a method of supplying time synchronization by a time synchronization system, the method comprising: transmitting, by an authentication server over a communication network to a time client device, a first key, and a first value containing the first key in encrypted form; during a time synchronization phase, receiving by a time server from the time client device, the first value and a second value generated using the first key; and authenticating, by the time server, the time client device based on the second value.

According to a further aspect, there is provided a method of generating a time estimation using an electronic device comprising a network interface for communicating over a communication network, the method comprising: requesting, by the electronic device from a node in a blockchain network, headers of a series of blocks of a blockchain; extracting a timestamp from the header of a most recent block of the series; and generating a time estimation based on the extracted timestamp.

According to one embodiment, the method further comprises: requesting, from a further node in the blockchain network, headers of the series of blocks of the blockchain; and extracting a further timestamp from the header of the most recent block of the series, wherein generating the time estimation is further based on the further timestamp.

According to one embodiment, the blockchain comprises a chain of blocks from a genesis block to an Nth most recently generated block, the header of the most recent block of the series being an (N−j)th block of the blockchain, where j is equal to between 6 and 15.

According to one embodiment, the method further comprises requesting from the node in the blockchain network the headers up to a most recent block of the blockchain, and identifying the (N′−j′)th block as the most recent block of the series.

According to one embodiment, each block in the blockchain, except for the genesis block, comprises a hash value of a previous block in the chain.

According to one embodiment, the blockchain is the blockchain of a crypto currency.

According to one embodiment, requesting, by the electronic device, headers of the series of blocks comprises requesting the headers of the blockchain starting from an initial block known to the electronic device.

According to one embodiment, the method further comprises, during a configuration phase, receiving by the electronic device a hash of the initial block.

According to a further aspect, there is provided a method of verifying an authentication certificate comprising: generating a time estimation according to the above method; and verifying, by the electronic device, the time validity of the authentication certificate based on the generated time estimation.

According to yet a further aspect, there is provided an electronic device comprising a network interface for communicating over a communication network, the electronic device being configured to: request, from a node in a blockchain network, headers of a series of blocks of a blockchain; extract a timestamp from the header of a most recent block of the series; and generate a time estimation based on the extracted timestamp.

According to one embodiment, the electronic device is further configured to: request, from a further node in the blockchain network, headers of the series of blocks of the blockchain; and extract a further timestamp from the header of the most recent block of the series, wherein generating the time estimation is further based on the further timestamp.

According to one embodiment, the blockchain comprises a chain of blocks from a genesis block to an Nth most recently generated block, the header of the most recent block of the series being an (N−j)th block of the blockchain, where j is equal to between 6 and 15.

According to one embodiment, the electronic device is further configured to request from the node in the blockchain network the headers up to a most recent block of the blockchain, and to identify the (N′−j′)th block as the most recent block of the series.

According to one embodiment, the electronic device is further configured to request headers of the series of blocks comprises requesting the headers of the blockchain starting from an initial block, wherein the electronic device stores a hash of the initial block.

According to one embodiment, the electronic device is further configured to verify the time validity of an authentication certificate based on the generated time estimation.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 (described above) schematically illustrates a system for providing time synchronization;

FIG. 2 schematically illustrates a system for providing time synchronization according to an example embodiment of the present disclosure;

FIG. 3 represents communications between network entities in the system of FIG. 2 according to an example embodiment of the present disclosure;

FIG. 4 schematically illustrates a system for securely generating a time estimation according to an example embodiment of the present disclosure;

FIG. 5 represents a blockchain according to an example embodiment of the present disclosure;

FIG. 6 is a flow diagram illustrating operations in a method of securely generating a time estimation according to an example embodiment of the present disclosure; and

FIG. 7 schematically illustrates a time client device according to an example embodiment of the present disclosure.

### DESCRIPTION OF EMBODIMENTS

Like features have been designated by like references in the various figures. In particular, the structural and/or functional features that are common among the various embodiments may have the same references and may dispose identical structural, dimensional and material properties.

Unless indicated otherwise, when reference is made to two elements connected together, this signifies a direct connection without any intermediate elements other than conductors, and when reference is made to two elements linked or coupled together, this signifies that these two elements can be connected or they can be linked or coupled via one or more other elements.

Unless specified otherwise, the expressions “around”, “approximately”, “substantially” and “in the order of” signify within 10%, and preferably within 5%.

Embodiments of a system for providing time synchronization and of a system for securely generating a time estimation are described in the publication by Faten Mkacher, Xavier Bestel and Andrzej Duda entitled “Secure Time Synchronization Protocol”, ISPCS 2018, Sep. 30 to Oct. 5, 2018, the contents of which is hereby incorporated by reference.

FIG. 2 schematically illustrates a system 200 for providing time synchronization according to an example embodiment of the present disclosure.

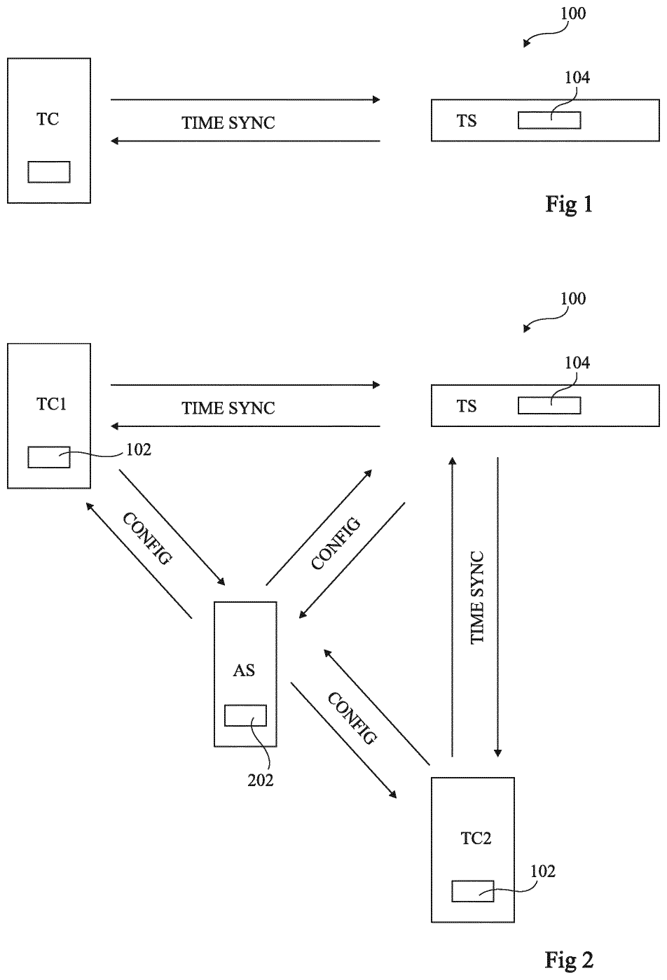

The system 200 comprises time client devices TC1 and TC2 each comprising a local clock 102 similar to that of the time client device TC of FIG. 1. Furthermore, each of the devices TC1, TC2 for example comprises a network interface for communicating over a network with a time server TS. The network is for example a packet-switched network including for example one or more LANs (local area networks), WLANS (wireless LANs) and/or the internet. While an example is illustrated with two time client devices, in practice the time server TS may serve many time client devices, for example hundreds or even thousands of such devices. In one example embodiment, the time client devices TC1, TC2 are points of sale, and the time server TS disseminates certified legal time to the points of sale for commercial transactions.

The time server TS is similar to the time server of FIG. 1, and comprises a relatively precise time source 104, which for example comprises a micro atomic oscillator or other means for maintaining a precise time reference. In some embodiments, the time source 104 is based on a Rubidium oscillator or an OCXO (Oven Controlled X-tal(crystal) Oscillator), although other types of oscillators would be possible.

The system 200 further comprises an authentication server AS, having for example a precise local clock 202.

Each of the time clients TC1 and TC2 may request time synchronization from the time server TS. For example, such requests may occur when the device TC1 or TC2 is activated for a first time, and/or at regular intervals throughout the lifetime of the devices TC1 and TC2 in order to maintain time synchronization. Indeed, the local clock 102 of each time client device TC1, TC2 for example deviates to some extent over time, and therefore by resynchronizing with the time server TS, the devices TC1 and TC2 are able to maintain relatively precise time, for example with a precision of a few milliseconds with respect to Coordinated Universal Time.

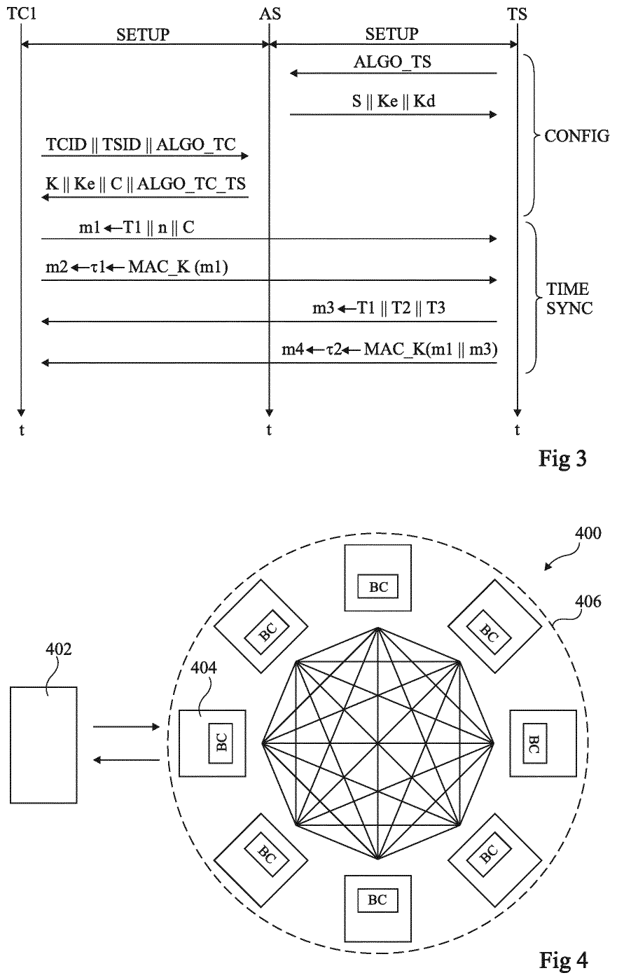

In order to allow secure time synchronization between the time client devices TC1 and TC2 and the time server TS, a configuration phase (CONFIG) is for example implemented using the authentication server AS. This for example involves communications between the authentication server AS and the time server TS, and between the authentication server AS and each time client device TC1, TC2. A method of performing this configuration phase and a subsequent time synchronization phase (TIME SYNC) with the time client device TC1 will now be described in more detail with reference to FIG. 3. A similar method could be performed for the time client device TC2.

FIG. 3 represents communications between the time client device TC1, the authentication server AS, and the time server TS of FIG. 2 according to an example embodiment of the present disclosure.

Prior to starting communications between the parties, a setup operation (SETUP) for example occurs in which mutual authentication based on certificates is implemented between the time client device TC1 and the authentication server AS, and between the time server TS and the authentication server AS. This for example involves the establishment of a DTLS (datagram transport layer security) session, as known by those skilled in the art. The DTLS session creates secure channels that are used to exchange messages during the configuration phase.

The configuration phase (CONFIG) between the time server TS and the authentication server AS is for example performed once, or at relatively infrequent intervals, for example once a month in order to refresh the cryptographic materials used during time synchronization. During this phase, the time server TS for example transmits to the authentication server AS its supported cryptographic algorithms ALGO_TS, including in some embodiments its supported MAC (message authentication code) and/or its supported DS (digital signature).

The authentication server AS for example responds by generating and transmitting to the time server TS a key S, which is for example a long term secret to be used by the time server TS. In the case that PKI (Public Key Infrastructure) is to be used to sign messages to the time client, the authentication server AS also for example generates and transmits to the time server TS a public key/private key pair Ke/Kd. The same keys S, Ke and Kd are for example used for communications with each time client device, so that the time server TS does not need to store a different key for use with each time client device.

The configuration phase (CONFIG) between the time client device TC1 and the authentication server AS (and between the other time client devices and the authentication server) is for example performed after the configuration phase with the time server TS described above. The time client device TC1 for example initiates the configuration phase by transmitting to the authentication server AS: its identifier TCID, which is for example in the form of an IP address of the time client device included automatically in the transmitted message; an identifier TSID of the time server TS with which the time client device TC1 wishes to perform time synchronization; and its supported cryptographic algorithms ALGO_TC, including in some embodiments its supported MAC and/or its supported digital signature DS. In alternative embodiments, the time client device TC1 does not transmit the identifier TSID of the time server TS, and instead the authentication server AS proposes a time server TS to the time client device TC1.

As will be described in more detail below, the time server TS is for example configured to authenticate the time synchronization messages it sends to the time client TC1 using either a MAC generated using a symmetric key K, or a digital signature DS generated using the private key Kd.

Assuming that at least one of the cryptographic algorithms supported by the time server TS is also supported by the time client device TC1, the authentication server AS for example responds by providing to the time client TC1 the symmetric key K, and in some cases the public key Ke of the time server TS, and the negotiated cryptographic algorithm(s) ALGO_TC_TS that is/are compatible with both the time server TS and the time client device TC1 and is/are to be used for the communications therebetween. For this purpose, the authentication server AS for example comprises a memory storing, for each time client device, and for each time server TS in the case that there is more than one, the relationships TSID-[S,(Ke,Kd)] and TCID-[K,C], where the identifiers TSID and TCID may correspond to IP addresses of the time server and time client device respectively.

The authentication server AS also for example provides to the time client device TC1 a state C, in the form of an encrypted value. In particular, the state C for example corresponds to the symmetric key K and in some embodiments one or more further values, all encrypted using the key S of the time server TS. The key K is for example unique for each time client device, and the use of the state C for example permits the time server to be stateless, in other words it does not need to store the key K associated with each time client device, as will be described in more detail below. The key S is for example not known to the time client device TC1, which cannot therefore decrypt or modify the state C. Only the time server TS is for example able to decrypt the state C. The further values encrypted in the state C may include a value indicating the negotiated algorithm(s) ALGO_TC_TS selected for use for communications between the time client device TC1 and the time server TS.

For example, the negotiated algorithm for communications between the time client device TC1 and the time server TS is the cryptographic primitive known as AES-GCM (Advanced Encryption Standard—Galois/Counter Mode) algorithm, or a Feistel cipher.

The MAC algorithms supported by the time server and/or by the time client device TC1 for example include the HMAC-SHA256 (Hash-based Message Authentication Code—Secure Hash Algorithm) algorithm, and/or the AES-CMAC (Advanced Encryption Standard—Cipher-based Message Authentication Code) algorithm, and/or the HMAC-MD5 (HMAC—Message Digest 5).

The digital signature DS supported by the time server and/or by the time client device TC1 for example includes the Ed25519 signature, which is an EdDSA (Edwards-curve Digital Signature Algorithm) using SHA-512 and Curve25519, and/or the MQQ-SIG (Multivariate Quadratic Quasigroups Signature) signature.

To initiate a time synchronization phase (TIME SYNC), the time client device TC1 for example transmits a message m1 to the time server TS. The message m1 for example includes data corresponding to the particular protocol to be used for time synchronization. For example, in the case of the NTP protocol, the message includes a timestamp T1 corresponding to the timestamp of the time client device TC1 at the time that the message m1 is generated and transmitted. Furthermore, the message m1 for example includes a nonce n, and the state C. The nonce n is for example a random value included in every message m1, and provides protection against replay attacks. For example the time server TS includes this nonce n, or a MAC or digital signature based on this nonce, in a future reply message (described in more detail below) to the time client device, which can thus verify that the nonce n is the same.

The time client device TC1 also for example transmits to the time server TS a second message m2 comprising a value T1 corresponding for example to a MAC value MAC_K(m1) generated using the symmetric key K. For example, this MAC value is a code generated based on the first message m1 already received by the time server TS. Alternatively, it could be generated based on only part of the message m1, for example based on the state C, or on the nonce n.

The messages m1 and m2 are for example transmitted independently, such that the time server TS can process the initial message m1 as soon as it is received without first verifying the MAC. As such, the quality of the time synchronization operation is improved. However, in alternative embodiments, the messages m1 and m2 could be transmitted as a single message.

The time server TS for example responds to the message m1 by generating and transmitting to the time client device TC1 a message m3 containing the timestamp T1, and also timestamps T2 and T3 in accordance with the NTP protocol. For example, the timestamp T2 corresponds to the reception time of the message m1 by the time server TS, and the timestamp T3 corresponds to the transmission time of the message m3 to the time client device TC1.

The time server TS also for example decrypts the encrypted value C based on its secret key S, and extracts therefrom the symmetric key K and in some embodiments the negotiated algorithm ALGO_TC_TS. The time server TS is then for example able to verify the MAC MAC_K(m1) provided in the message m2 based on the symmetric key K.

The time server TS also for example transmits a message m4 to the time client device TC1 after the message m3, the message m4 being used for authentication. For example, the message m4 comprises a value τ2 corresponding for example to a MAC code MAC_K(m1∥m3) generated using the symmetric key K and based on at least one of the messages m1 and m3, and preferably based on both the messages m1 and m3. Alternatively, the authentication could be provided by a digital signature DS_kd(m1∥m3), corresponding to a signature of at least one of the messages m1 and m3, and preferably based on both the messages m1 and m3. This digital signature is for example generated using the private key Kd of the time server TS. In some cases, the time server TS is capable of generating both the MAC code MAC_K(m1∥m3) and the digital signature DS_kd(m1∥m3), and a selection is made, for example by the time client device TC1, between these two types of message authentication types based on whether or not the non-repudiation property is desired.

In alternative embodiments, the MAC and/or digital signature could be generated based on only part of the messages m1 and m3, for example based only on the nonce of the message m1 and/or on only the timestamps T2 and T3 of the message m3.

The time client device TC1 is then able to determine a relatively precise estimation of the time by calculating the time offset of its local clock 102 with respect to the clock 104 of the time server TS and the round-trip time RTT of the communications between time client TC1 and the time server TS, which are for example determined by the following equations:

$$\begin{matrix}Offset = \frac{( T 2 - T 1 ) - ( T 4 - T 3 )}{2} & [ Math . 1 ] \\ \\ RTT = ( T 4 - T 1 ) - ( T 3 - T 2 ) & [ Math . 2 ]\end{matrix}$$

where T4 is a timestamp corresponding to the reception time of the message m3 by the time client device TC1.

The time client device TC1 is for example configured to adjust its clock based on the computed values of Offset and RTT. As will be appreciated by those skilled in the art, in some cases the time synchronization operation is repeated multiple times, and the clock adjustment is based on a filtering and/or statistical analysis of the computed set of values of Offset and RTT. Furthermore, in some embodiments, the value of RTT is compared to a threshold parameter A, and the time client device TC1 is configured to reject the message m4 and/or abort the time synchronization if the value of RTT exceeds the threshold parameter A, thereby defending against delay attacks.

The time client device TC1 also for example authenticates the time information provided by the time server TS by verifying the authentication code or digital signature provided with the message m4. In the case that the message m4 includes the MAC code MAC_K(m1∥m3), the time client device TC1 for example verifies this code based on the symmetric key K, for example by recalculating the MAC, and comparing the recalculated MAC with the one provided with the message m4. In the case that the message m4 includes the digital signature DS_kd(m1∥m3), the time client device TC1 for example verifies this signature by decrypting the signature using its public key Ke.

As described above in relation with FIG. 3, initial communications between the authentication server AS and the time client device TC1 and time server TS correspond to a setup phase during which mutual authentication is performed, based for example on an exchange of certificates. However, the time client device TC1 may be a device that does not have a synchronous clock and thus has no notion of time upon being power-up for the first time.

A system and method of securely obtaining, by an electronic device, a time estimation will now be described with reference to FIGS. 4 to 6. The electronic device could correspond to the time client device TC1 or TC2 of FIG. 2 for the purposes of certificate validation, or to any electronic device wishing to obtain an estimate of the current time.

FIG. 4 schematically illustrates a system 400 for generating a time estimation according to an example embodiment of the present disclosure.

In the system 400, an electronic device 402 wishes to obtain an estimate of the current time. For example, the device 402 is a device with no user interface, or with a user interface that does not permit time information to be entered. In some embodiments, the device 402 is a portable electronic device capable of wireless communications, such as an IoT (Internet of Things) device.

According to the embodiments described herein, the time estimation is obtained using a blockchain network 406. The blockchain network 406 for example comprises J nodes, each storing similar versions of a same blockchain BC. The number J of nodes is for example equal to at least 2, and could be equal to hundreds or thousands. The device 402 requests certain data of the blockchain BC from a node 404 of a blockchain network 406.

The blockchain BC is for example an immutable public blockchain, such the blockchain of a crypto currency such as Bitcoin or the like (the name “Bitcoin” may correspond to a registered trademark). As known by those skilled in the art, a blockchain network is, by design, a trusted source due to its particular structure.

A timestamp is for example obtained by the device 402 from one or more blocks of the blockchain using peer-to-peer access. Peer-to-peer access to the Bitcoin blockchain is for example described in more detail in the publication by S. Nakamoto entitled “Bitcoin: A peer-to-peer Electronic Cash System”, May 2011. In some embodiments, the device 402 requests the headers of a series of blocks of the blockchain BC, and extracts a timestamp from one of these headers.

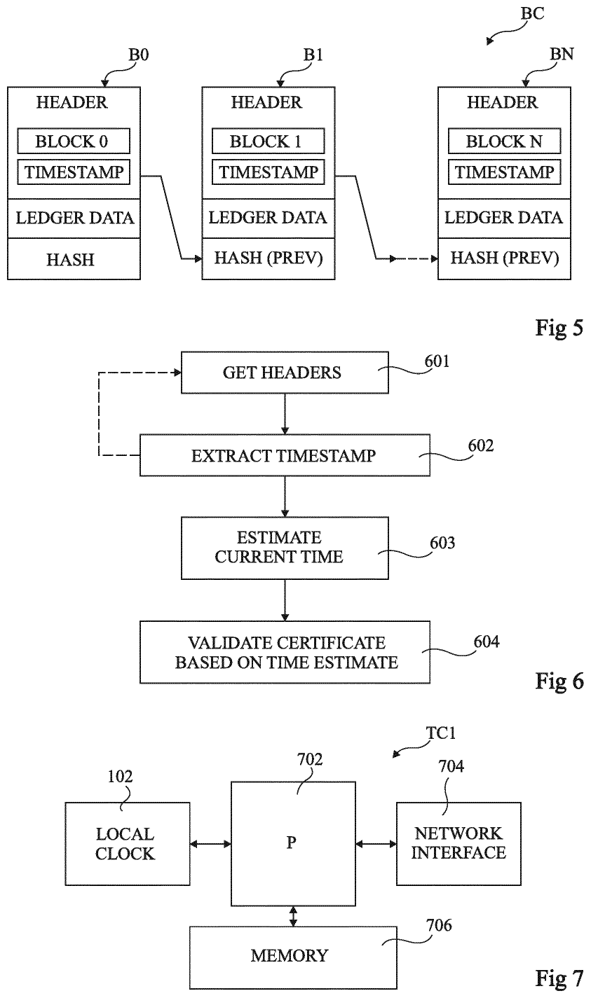

FIG. 5 represents the blockchain BC of FIG. 4 according to an example embodiment. The blockchain BC for example comprises blocks B0 to BN, the block B0 being a genesis block of the blockchain BC, and the block BN being the most recent block of the blockchain BC. Each block for example comprises a header (HEADER) containing an identifier (BLOCK 0 to BLOCK N) of the block, and a timestamp (TIMESTAMP). Each block further comprises data, which in the case of the crypto currency bloc for example corresponds to ledger data (LEDGER DATA). Furthermore, the genesis block B0 includes a hash (HASH) of itself, and each other block further includes a hash of the previous block (HASH (PREV)), thereby rendering it difficult for older blocks to be modified without the approval of the majority of the nodes in the blockchain network.

FIG. 6 is a flow diagram illustrating operations in a method of generating a time estimation according to an example embodiment of the present disclosure.

It is assumed that, during an initial configuration operation, which is for example a factory configuration, the device 402 has been configured with the hash of the (N−j)th block in the blockchain, where N is the last block in the chain at the time of the initial configuration operation. For example, j is equal to between 6 and 15, and is equal to 10 in one example. By using a block that is not the most recent in the chain, the block can be considered immutable due to the presence of one or more additional blocks in the chain.

It is also assumed that the device 402 has for example identified the node 404 as a peer in the blockchain network 406 and knows the IP address of this peer. For example, the device 402 has performed an operation of peer discovery, for example using several DNS seeds or hardcoded IP addresses.

In an operation 601, the electronic device 402 requests a series of headers from the peer 404 in order to perform header synchronization with the peer 404, and without storing the whole blockchain. A “GetHeaders” command is for example used. The command is for example of the form GetHeaders(X,L), where X is the identifier of the earliest block requested, and L is the number of headers requested. In the case of Bitcoin nodes, a maximum of 2000 headers can be supplied. The device 402 for example requests the headers starting from the (N−j)th block hash, which is for example known to the device 402 from the initial configuration operation.

In response, the peer 404 for example takes the hash of the (N−j)th block, and replies to the device 402 with the requested series of L headers chained after the (N−j)th block. The device 402 then for example repeats the header synchronization until the most recent block N′ of the blockchain is reached, and identifies the header of the block N′−j′ in the series. Alternatively, the device 402 only requests the headers of the blocks up to the (N′−j′)th block.

Indeed, like during the initial configuration operation, in some embodiments, a certain number of headers of the most recent blocks, which may still be subject to change and are thus not necessarily immutable, are excluded from the request, or are requested, but subsequently ignored. For example, the device 402 identifies the header of the (N′-j′)th block, where the N'th block is the most recent block, and j′ is equal to between 6 and 15, and in one example is equal to 10. In some embodiments, j′ and j are equal.

In an operation 602, the electronic device 402 extracts the timestamp from the header of the block N′−j′. In some embodiments, this timestamp has the same format as the 64-bit timestamp used in NTP, while in other embodiments the format of the blockchain timestamp could be different and converted into the appropriate format.

As represented by a dashed arrow in FIG. 6, the operations 601 and 602 may be repeated for one or more other nodes or peers of the blockchain in order to provide further verification that the headers are genuine, and to protect against MITM (man-in-the-middle) and masquerade attacks. For example, this involves requesting the headers of the series of blocks from the further peer from the (N−j)th block hash up to an (N′−j′)th block, or up to the most recent block N′, identifying the header of the (N′−j′)th block and extracting the timestamp from this header. The new timestamp is for example compared to the previously extracted timestamp in order to verify that they are identical, thereby verifying the time stamp based on at least two separate nodes.

In an operation 603, a current time is estimated based on the extracted timestamp(s), and a local clock 102 of the electronic device 402 is for example synchronized based on the time estimate.

Because the timestamp that is relied upon is not from the most recent block of the blockchain, there is likely to be a time offset between the time of the extracted timestamp and the actual time, which will depend on the value of j′. The present inventors have found however that it is generally possible to select a value of j′ that provides a time that is accurate to within a few hours, generally enough for validating an authentication certificate. Indeed, such certificates are generally valid up until a certain date. The choice of the parameter j′ is for example based on the validity property of the timestamp in the block chain.

In an operation 604, a certificate is for example validated based on the time estimate. Thus a revoked certificate can be identified and rejected by the device 402. Alternatively, other uses could be made of the generated time estimate.

FIG. 7 schematically illustrates the time client device TC1 of FIG. 2 in more detail according to an example embodiment.

The device TC1 for example includes a processing device (P) 702 comprising one or more processing cores. The processing device 702 is for example coupled to a local clock (LOCAL CLOCK) 102, which for example comprises a local oscillator, such as a quartz oscillator or the like, and one or more counters. The device TC1 also for example comprises a network interface (NETWORK INTERFACE) 704 and a memory (MEMORY) 706 coupled to the processing device 702.

The memory 706 for example stores instructions that, when executed by the processing device 702, cause the operations of the time client device TC1 described above in relation with FIG. 3 to be implemented.

The time client device TC2, the authentication server AS, and the electronic device 402 of FIG. 4, are for example implemented by similar circuits to that of FIG. 2. The time server TS is also for example implemented by a similar circuit, except that, instead of or in addition to the local clock 102, the time server TS comprises the secure time source 104. Furthermore, in the case of the device 402, its memory for example stores instructions that implement the method described above in relation with FIG. 6. In the case of the time server TS and of the authentication server AS, these devices also for example comprise memories storing instructions that implement the operations of these devices described above in relation with FIG. 3.

An advantage of the embodiments described in relation with FIGS. 2 and 3 is that the authentication server AS relieves the time server TS of a significant amount of the burden, in particular algorithm negotiation and key exchanges. This permits the time server TS to handle time synchronization operations with a relatively high number of time client devices and permits relatively high availability of the time server TS. Despite the use of the authentication server AS, the exchanges between the time client device and the time server TS are rendered secure by the generation and transmission to the time server of an authentication code by the time client device based on the symmetric key K supplied by the authentication server AS. Furthermore, by permitting the time server TS to be authenticated using a digital signature based on asymmetric keys, non-repudiation can be supported, while time-critical operations still rely on symmetric cryptography using the symmetric key K.

An advantage of the embodiments described in relation with FIGS. 4 to 6 is that a secure time estimation can be obtained in a relatively simple and secure manner. Indeed, the time information contained in the headers of the blocks of a blockchain provides a rough time estimation that is validated by all peers in the blockchain network.

Various embodiments and variants have been described. Those skilled in the art will understand that certain features of these embodiments can be combined and other variants will readily occur to those skilled in the art. In particular, it will be apparent to those skilled in the art that, while embodiments have been described in relation with the NTP protocol, the principles described herein could be applied to any time synchronization protocols. Furthermore, while embodiments have been described in which one or more cryptographic algorithms to be used for communications between a time client device and the time server are negotiated, in alternative embodiments such a negotiation can be omitted if for example a single cryptographic algorithm is designated for use by all time client devices for each particular cryptographic operation (encryption, MAC generation, DS generation).

Furthermore, while FIG. 5 provides one example of a blockchain, the principles described herein could be applied to a broad range of blockchain types in which each block includes a timestamp.

It will also be apparent to those skilled in the art that the embodiment of FIG. 2 could be combined with the embodiment of FIG. 4, the time client device TC1 being capable of obtaining a time estimation in order to validate an authentication certificate, for example in relation with a DTLS session, prior to the configuration phase with the authentication server AS.

1. A time client device comprising a network interface for communicating over a communication network, the time client device being configured to:
receive, over the communication network from an authentication server, a first key, and a first value containing the first key in encrypted form;
generate a second value using the first key; and
during a time synchronization phase, transmit to a time server the first and second values.

2. The time client device of claim 1, configured, during the time synchronization phase, to:
transmit the first value to the time server in a first message comprising a first timestamp; and
transmit the second value to the time server in a second message.

3. The time client device of claim 2, wherein the second value is a message authentication code of the first message generated using the first key.

4. The time client device of claim 1, wherein the first value further contains an indication of an encryption algorithm to be used to generate the second value.

5. The time client device of claim 1, further configured to transmit over the communication network a request to the authentication server for the first key and the first value, the request containing an identifier of the time client device, the identifier for example being an IP (Internet Protocol) address.

6. The time client device of claim 5, configured to further include in the request an identifier of the time server, the identifier of the time server for example being an IP address.

7. The time client device of claim 1, wherein the first value is encrypted using a second key not known by the time client device.

8. The time client device of claim 1, further configured to:
receive from the time server a third message containing one or more further timestamps;
receive from the time server a third value corresponding to: a message authentication code of at least part of the first message and/or at least part of the third message generated using the first key; or a digital signature of at least part of the first message and/or at least part of the third message generated based on a private key; and
authenticate the third message by verifying the third value, based on the first key or on a public key.

9. The time client device of claim 1, further configured to:
generate a time estimation by requesting from a node in a blockchain network headers of a series of blocks of a blockchain, extracting a timestamp from the header of a most recent block of the series; and generating the time estimation based on the extracted timestamp; and
validate an authentication certificate of the authentication server based on the time estimation.

10. A time synchronization system comprising:
an authentication server comprising a network interface for communicating over a communication network, the authentication server being configured to transmit, over the communication network to a first time client device, a first key, and a first value containing the first key in encrypted form; and
a time server configured to receive from the first time client device, during a time synchronization phase, the first value and a second value generated using the first key, the time server being configured to authenticate the first time client device based on the second value.

11. The time synchronization system of claim 10, wherein:
the authentication server is further configured to transmit, over the communication network to a second time client device, a third key, and a third value containing the third key in encrypted form; and
the time server is further configured to receive from the second time client device, during a time synchronization phase, the third value and a fourth value generated using the third key, the time server being configured to authenticate the second time client device based on the fourth value.

12. A method of obtaining time synchronization by a time client device comprising a network interface for communicating over a communication network, the method comprising:
receiving, over the communication network from an authentication server, a first key, and a first value containing the first key in encrypted form;
generating, by the time client device, a second value using the first key; and
during a time synchronization phase, transmitting by the time client device the first and second values to a time server.

13. A method of supplying time synchronization by a time synchronization system, the method comprising:
transmitting, by an authentication server over a communication network to a time client device, a first key, and a first value containing the first key in encrypted form;
during a time synchronization phase, receiving by a time server from the time client device, the first value and a second value generated using the first key; and
authenticating, by the time server, the time client device based on the second value.
